(19) United States
(12) Patent Application Publication
(10) Pub. No.: US 2012/0025643 A1
(43) Pub. Date: Feb. 2, 2012

(54) MOTOR WITH SPEED REDUCTION MECHANISM

(75) Inventors: Hiroyuki Shibusawa, Gunma (JP); Masaki Mita, Gunma (JP)

(73) Assignee: Mitsuba Corporation, Kiryu-shi, Gunma (JP)

(21) Appl. No.: 13/258,052

(22) PCT Filed: Mar. 15, 2010
(86) PCT No.: PCT/JP2010/054352

§ 371 Date: Oct. 12, 2011

(30) Foreign Application Priority Data
Mar. 25, 2009 (JP) 2009-073529

(51) Int. Cl. H02K 11/00

(52) U.S. Cl. 310/71

(57) ABSTRACT

A power supply terminal 76a and a ground terminal 76b are respectively disposed on both sides of a connector junction 72 in longitudinal direction, and the control terminals 77a to 77f are disposed between the power supply terminal 76a and the ground terminal 76b, arranged in two rows in longitudinal direction of the connector junction 72, and arranged in three rows in lateral direction of the connector junction 72. Therefore, it is possible to separate the power supply terminal 76a from the ground terminal 76b. And it is possible to reduce the connector junction 72 in size while securing a sufficient air gap (distance L) between the power supply terminal 76a and the ground terminal 76b. Further, it is possible to reduce the power window motor in size.

### CROSS REFERENCE TO RELATED APPLICATIONS

This application is entitled to the benefit of and incorporates by reference essential subject matter disclosed in International Patent Application No. PCT/JP2010/054352 filed on Mar. 15, 2010 and Japanese Patent Application No. 2009-073529 filed Mar. 25, 2009.

### TECHNICAL FIELD

The present invention relates to a motor with speed reduction mechanism having a speed reduction mechanism for reducing the speed of rotation of a rotating shaft and outputting the speed-reduced rotation and a controller for controlling the rotation of the rotating shaft.

### BACKGROUND ART

Conventionally, a motor with speed reduction mechanism capable of obtaining a large output in spite of its small size is used as a drive source of a power window device to be mounted on a vehicle such as an automobile and the like. When an operator operates an operation switch provided in a passenger compartment and the like, the motor with speed reduction mechanism is driven in rotation so as to open and close a window glass. It is indispensible to downsize the motor with speed reduction mechanism to be used for the power window device because the motor is mounted in a narrow space such as inside of a door and the like of a vehicle. In this way, it is possible to enhance layout property in any of large and small vehicles.

As the motor with speed reduction mechanism like this, for example, a technology disclosed in Japanese Patent Application Laid-Open Publication No. 2008-141912 is known. The motor with speed reduction mechanism disclosed in Japanese Patent Application Laid-Open Publication No. 2008-141912 includes a motor case (yoke) and a gear case, and further includes a board case for holding a control board (controller) for controlling the rotation of a motor shaft (rotating shaft) provided in the motor case. The board case is provided with a connector opening portion (connector junction), and a vehicle-side connector is inserted into the connector opening portion. One end portions (terminals) of conductive members are disposed in the connector opening portion, and the conductive members include a power supply terminal (power supply conductive member) and a ground terminal (ground conductive member) which are larger than the other conductive members.

### SUMMARY OF THE INVENTION

However, according to the motor with speed reduction mechanism disclosed in Japanese Patent Application Laid-Open Publication No. 2008-141912, the power supply terminal and the ground terminal are situated close to each other in the connector opening portion and arranged side by side in its lateral direction, so it is necessary to size up the connector opening portion to some extent in its lateral direction. That is, a sufficient air gap is secured (insulation property is secured) between the power supply terminal and the ground terminal by sizing up the connector opening portion to some extent in its lateral direction, so it is possible to guarantee the stable operation of the motor with speed reduction mechanism for a long period of time. Therefore, in the motor with speed reduction mechanism disclosed in Japanese Patent Application Laid-Open Publication No. 2008-141912, the size of the connector opening portion may cause a problem in downsizing of the motor with speed reduction mechanism.

An object of the invention is to provide a motor with speed reduction mechanism improved so as to downsize a connector junction while securing a sufficient air gap between a power supply terminal and a ground terminal.

A motor with speed reduction mechanism according to the present invention has a speed reduction mechanism for reducing the speed of rotation of a rotating shaft and outputting the speed-reduced rotation and a controller for controlling the rotation of the rotating shaft, the motor comprising: a motor case; an armature shaft provided in the motor case and forming the rotating shaft; a gear case attached to the motor case; a worm shaft provided in the gear case and coupled with the armature shaft to form the rotating shaft; a worm provided to the worm shaft and forming the speed reduction mechanism; a worm wheel provided in the gear case and meshed with the worm to form the speed reduction mechanism; a connector member attached to the gear case and configured to hold the controller; a connector junction provided to the connector member and having a rectangular shape in cross section; and eight conductive members inserted into the connector member, one end portions of the conductive members being disposed in the connector junction, and the other end portions of the conductive members being electrically connected to the controller, wherein two of the conductive members are respectively used as power supply conductive members, the other six conductive members are respectively used as control conductive members, one end portions of the power supply conductive members are respectively disposed on both sides of the connector junction in longitudinal direction, and one end portions of the control conductive members are disposed between the power supply conductive members, arranged in two rows in longitudinal direction, and arranged in three rows in lateral direction.

A motor with speed reduction mechanism according to the present invention has a speed reduction mechanism for reducing the speed of rotation of a rotating shaft and outputting the speed-reduced rotation and a controller for controlling the rotation of the rotating shaft, the motor comprising: a motor case in which one end portion of the rotating shaft is provided; a gear case attached to the motor case and having the other end portion of the rotating shaft provided therein; a worm provided to the other end portion of the rotating shaft and forming the speed reduction mechanism; a worm wheel provided in the gear case and meshed with the worm to form the speed reduction mechanism; a connector member attached to the gear case and configured to hold the controller; a connector junction provided to the connector member and having a rectangular shape in cross section; and eight conductive members inserted into the connector member, one end portions of the conductive members being disposed in the connector junction, and the other end portions of the conductive members being electrically connected to the controller, wherein two of the conductive members are respectively used as power supply conductive members, the other six conductive members are respectively used as control conductive members, one end portions of the power supply conductive members are respectively disposed on both sides of the connector junction in longitudinal direction, and one end portions of the control conductive members are disposed between the power supply conductive members, arranged in two rows in longitudinal direction, and arranged in three rows in lateral direction.

In the motor with speed reduction mechanism according to the present invention, each of the power supply conductive members is formed into a flat plate, each of the control conductive members is formed into a needle shape, and one end portions of the power supply conductive members are disposed in the connector junction so that the longitudinal direction of the power supply conductive members becomes parallel with the longitudinal direction of the connector junction.

In the motor with speed reduction mechanism according to the present invention, the motor with speed reduction mechanism is a power window motor mounted on a vehicle, one end portions of the power supply conductive members are respectively used as a power supply terminal and a ground terminal, and one end portions of the control conductive members are respectively used as a window automatic opening/closing terminal, a window lifting terminal, a window lowering terminal, an ignition detecting terminal, a serial communication terminal, and a spare terminal.

According to the present invention, since two of the power supply conductive members are respectively used as power supply conductive members, the other six power supply conductive members are respectively used as control conductive members, one end portions of the power supply conductive members are respectively disposed on both sides of the connector junction in longitudinal direction, and one end portions of the control conductive members are disposed between the power supply conductive members, arranged in two rows in longitudinal direction, and arranged in three rows in lateral direction, it is possible to separate one end portions of the power supply conductive members from each other. Therefore, it is possible to reduce the connector junction in size while securing a sufficient air gap between one end portions of the power supply conductive members. Further, it is possible to reduce the motor with speed reduction mechanism in size.

According to the present invention, since each of the power supply conductive members is formed into a flat plate, each of the control conductive members is formed into a needle shape, and one end portions of the power supply conductive members are disposed in the connector junction so that the longitudinal direction of the power supply conductive members becomes parallel with the longitudinal direction of the connector junction, it is possible to reduce the connector junction in size in lateral direction.

According to the present invention, since the motor with speed reduction mechanism is a power window motor mounted on an automobile, one end portions of the power supply conductive members are respectively used as a power supply terminal and a ground terminal, and one end portions of the control conductive members are respectively used as a window automatic opening/closing terminal, a window lifting terminal, a window lowering terminal, an ignition detecting terminal, a serial communication terminal, and a spare terminal, it is possible to reduce the power window device in size, while securing functions necessary as the power window device.

### BRIEF DESCRIPTION OF THE DRAWINGS

FIG. 1 is a partial cross-sectional view showing a power window motor according to the first embodiment of the present invention;

FIG. 2 is a view of the power window motor of FIG. 1 seen from the direction of an arrow “A”;

FIG. 3 is a perspective view showing the inside of a connector member;

FIG. 4 is an enlarged view of a portion “B” circled by a dashed line in FIG. 3;

FIG. 5 is a view of the connector member shown in FIG. 3 seen from the direction of an arrow “C”;

FIG. 6 is a view for explaining a procedure of assembling the power window motor; and

FIG. 7 is a partial cross-sectional view showing a power window motor according to the second embodiment of the present invention.

### BEST MODE FOR CARRYING OUT THE INVENTION

Hereinafter, embodiments of the present invention will be described in detail with reference to the drawings.

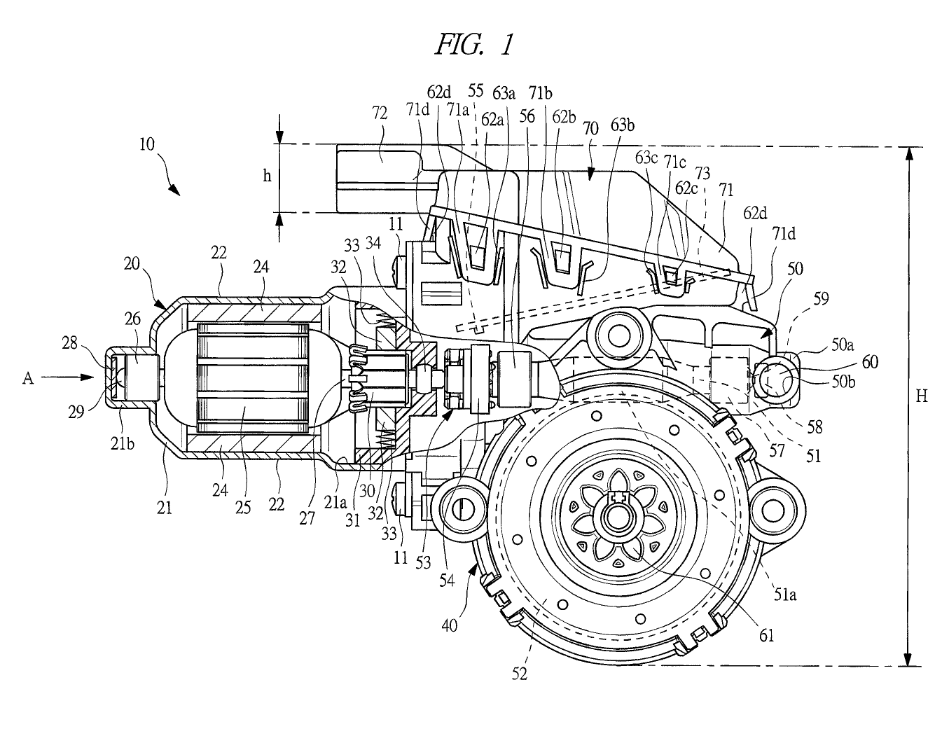

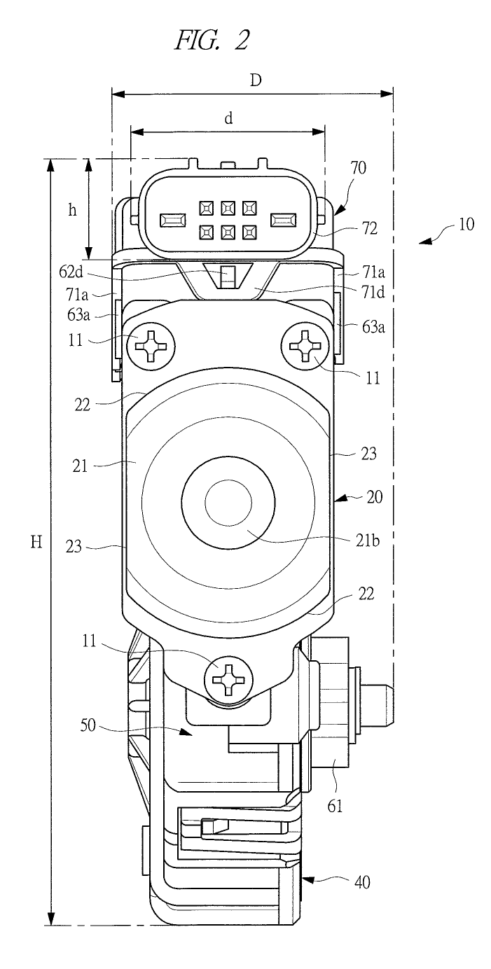

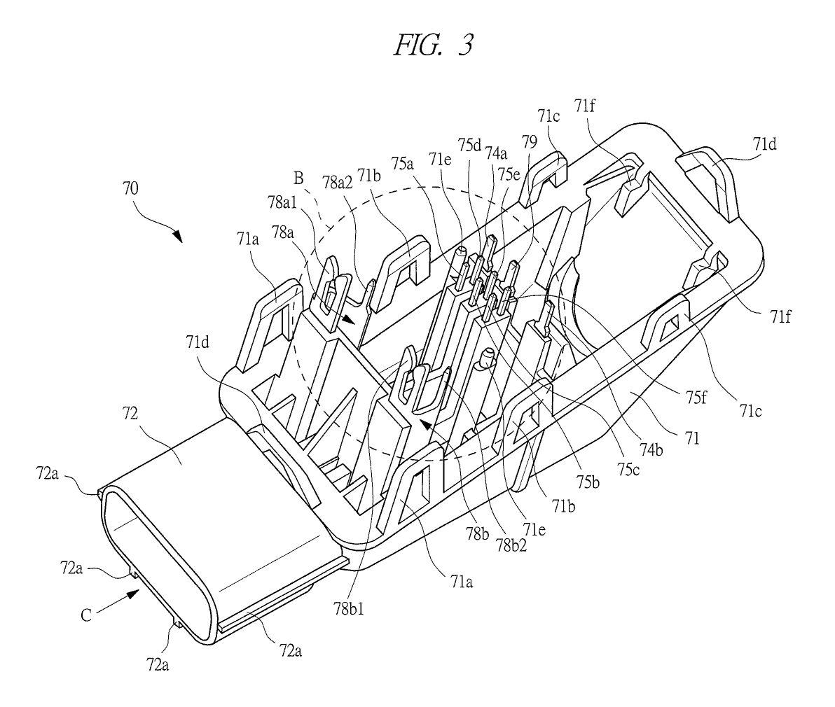

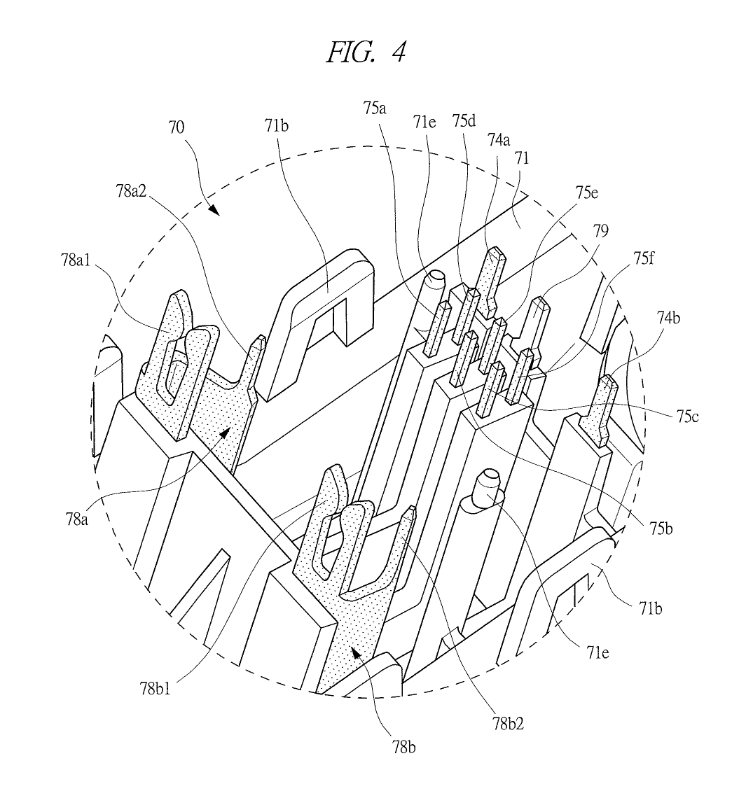

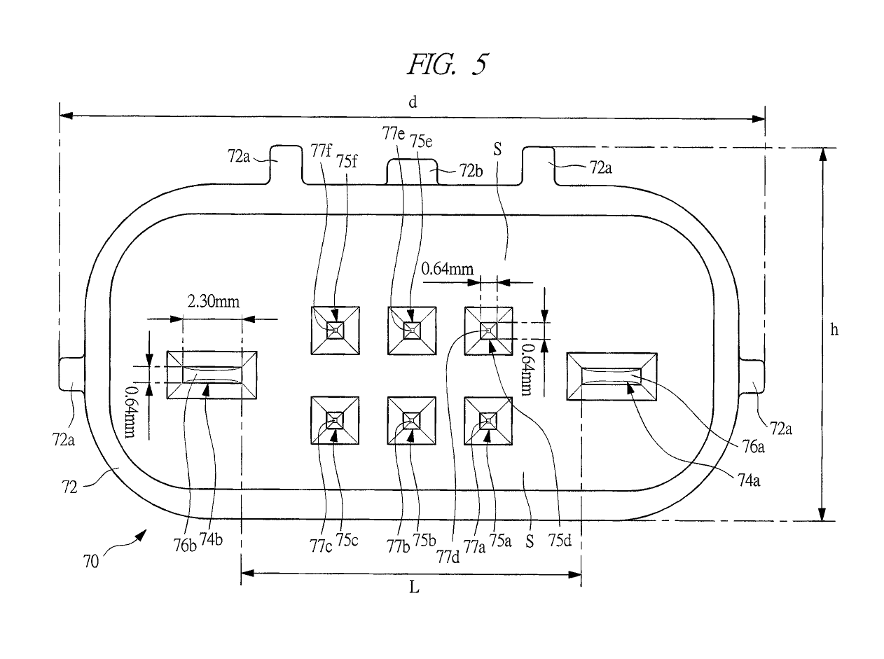

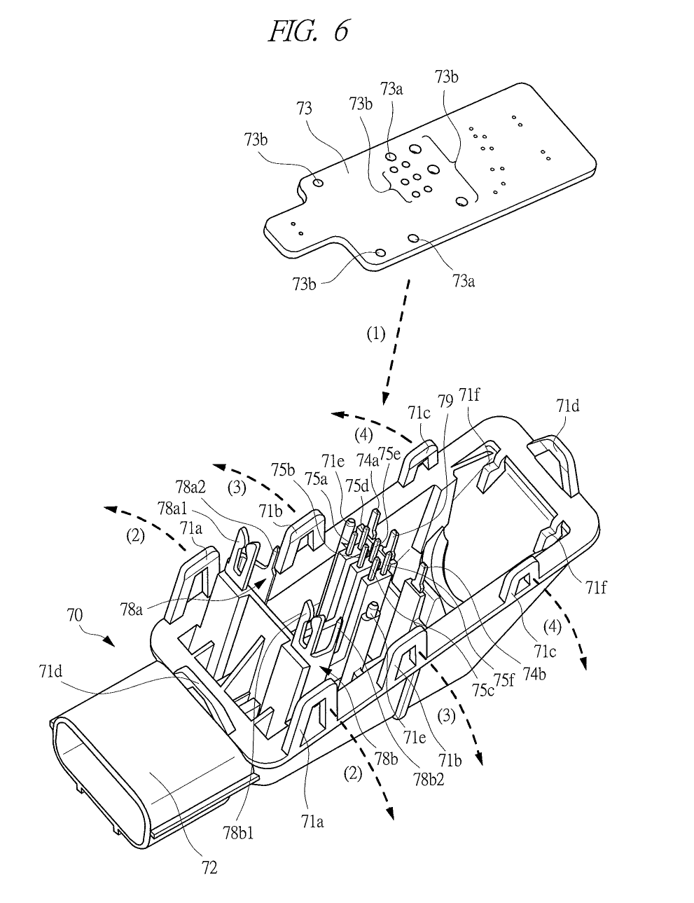

FIG. 1 is a partial cross-sectional view showing a power window motor according to the first embodiment. FIG. 2 is a view of the power window motor shown in FIG. 1 seen from the direction of an arrow “A”. FIG. 3 is a perspective view showing the inside of a connector member. FIG. 4 is an enlarged view of a portion “B” circled by a dashed line in FIG. 3. FIG. 5 is a view of the connector member shown in FIG. 3 seen from the direction of an arrow “C”. FIG. 6 is a view for explaining a procedure of assembling the power window motor.

As shown in FIGS. 1 and 2, a power window motor 10 as a motor with speed reduction mechanism is used as a drive source of a power window device (not shown) mounted on a vehicle such as an automobile and the like. The power window motor 10 is adapted to drive a window regulator (not shown) to lift up and down a window glass (not shown) provided to a door and the like of a vehicle. Since the power window motor 10 is installed in a narrow space (not shown) formed in a door of a vehicle, the power window motor 10 is formed in a thin shaped with a reduced thickness “D”.

The power window motor 10 includes a motor portion 20 and a gear portion 40, and the motor portion 20 and the gear portion 40 are integrated (made into a unit) by three fastening screws 11.

The motor portion 20 includes a yoke (motor case) 21 which is formed into a bottomed shape so as to have an opening portion 21a by pressing (deep-drawing) a steel sheet composed of magnetic material. The outside shape of the yoke 21 has an outer shape which is formed of a pair of arc-shaped surfaces 22 and a pair of flat surfaces 23 connected to each other via the arc-shaped surfaces 22, and the yoke 21 is substantially oval in cross-section. A pair of magnets 24 is disposed to the corresponding insides of the arc-shaped surfaces 22 in face-to-face relationship with each other, and an armature 25 around which coils (not shown) are wound is disposed inside the respective magnets 24. The armature 25 is rotatable in the yoke 21.

A bottom portion of the yoke 21 (left side in FIG. 1) is formed into a stepped shape, and provided with a bottomed cylinder portion 21b smaller in diameter than a main body portion of the yoke 21. A first radial bearing 26 is attached to the bottomed cylinder portion 21b by press fit, and rotatably supports one end portion (left side in FIG. 1) of an armature shaft 27. Further, a first thrust bearing 28 is provided to the bottomed cylinder portion 21b, and a first steel ball 29 is disposed between the first thrust bearing 28 and the armature shaft 27. As described above, one end portion of the armature shaft 27 is rotatably supported by the bottomed cylinder portion 21b via the first radial bearing 26, the first thrust bearing 28, and the first steel ball 29.

The armature shaft 27 as a rotating shaft is passed through and fixed to the center of rotation of the armature 25, and the armature shaft 27 is provided in the yoke 21. A commutator 30 is provided in the vicinity of the armature 25 on the side of the other end portion (right side in FIG. 1) of the armature shaft 27, and electrically connected to an end of the coil wound around the armature 25. A pair of brushes 32 held by a brush holder 31 is in sliding contact with the outer peripheral portion of the commutator 30, and the brushes 32 are respectively pressed toward the commutator 30 by spring members 33 at a predetermined pressure. Then, when a driving current is supplied to the brushes 32 from a vehicle-mounted battery (not shown) and the like, a rotation force (electromagnetic force) is generated by the armature 25, and the armature shaft 27 rotates at a predetermined rotation speed and a predetermined rotation torque.

The brush holder 31 is formed into a substantially oval shape in accordance with the inside shape of the opening portion 21a of the yoke 21, pressed into and fixed to the opening portion 21a so as to be entirely accommodated in the opening portion 21a. The brush holder 31 includes a second radial bearing 34 in addition to the brushes 32 and the spring members 33, and the second radial bearing 34 is fixed to a substantially center portion of the brush holder 31. The second radial bearing 34 rotatably supports the other end portion of the armature shaft 27.

As described above, since the first radial bearing 26, the first thrust bearing 28, and the first steel ball 29 are provided to one end portion of the armature shaft 27 and the second radial bearing 34 is provided to the other end portion of the armature shaft 27, the armature shaft 27, i.e., the armature 25 can smoothly rotate without generating almost any rotation resistance.

The gear portion 40 includes a gear case 50 and a connector member 70 attached to the gear case 50.

The gear case 50 is formed into a bottomed shape by injection molding of a resin material such as plastic and the like, and attached to the opening portion 21a of the yoke 21. A worm shaft 51 as a rotating shaft integrally formed with a worm 51a (not shown in detail) at its peripheral portion and a worm wheel 52 having gear teeth (not shown) meshed with the worm 51a are rotatably accommodated in the gear case 50.

The worm shaft 51 and the armature shaft 27 are disposed in coaxial relationship with each other, and one end portion of the worm shaft 51 and the other end portion of the armature shaft 27 are coupled with each other via a coupling member 53 so that they can rotate integrally. An elastic member such as rubber and the like (not shown) is attached in the coupling member 53, and elastically deformed when the worm shaft 51 is coupled with the armature shaft 27, thereby absorbing an offset of shaft (size error and the like) between the worm shaft 51 and the armature shaft 27. Further, an annular sensor magnet 54 is attached to the outer periphery side of the coupling member 53, and the sensor magnet 54 has a Hall IC 55 disposed in confrontation therewith. The sensor magnet 54 and the Hall IC 55 form a rotation sensor for detecting the speed of rotation and the like (rotating states) of the rotating shafts (the armature shaft 27 and the worm shaft 51).

Both end portions of the worm 51a of the worm shaft 51 in its axial direction are rotatably supported by a third radial bearing 56 and a fourth radial bearing 57 provided in the gear case 50, respectively. Further, a second thrust bearing 58 provided to a bottom portion 50a of the gear case 50 is disposed to the other end portion of the worm shaft 51, and a second steel ball 59 is provided between the second thrust bearing 58 and the worm shaft 51. The third radial bearing 56, the fourth radial bearing 57, the second thrust bearing 58, and the second steel ball 59 smoothly rotate the worm shaft 51. As described above, the bottom portion 50a rotatably supports the other end portion of the worm shaft 51 via the fourth radial bearing 57, the second thrust bearing 58, and the second steel ball 59.

A filling hole 50b is provided on the side of the bottom portion 50a of the gear case 50, and the filling hole 50b is filled with resin material 60 for adjusting the position of the second thrust bearing 58 in its axial direction. That is, after the power window motor 10 is assembled, the filling hole 50b is filled with the melted resin material 60 at a predetermined pressure, thereby moving the worm shaft 51 and the armature shaft 27 in their axial direction via the second thrust bearing 58, and eliminating plays of the worm shaft 51 and the armature shaft 27 in the axial direction. Here, the melted resin material 60 filled in the filling hole 50b is cured for a predetermined period of time under the condition that a predetermined pressure is being applied to the melted resin material 60 filled in the filling hole 50b.

Additionally, not only a method of using the resin material 60 but also a method of having the worm shaft 51 and the armature shaft 27 shift in the axial direction by adjusting an adjusting screw (not shown) which is screwed to the bottom portion 50a of the gear case 50 is employed as a method of eliminating the plays of the worm shaft 51 and the armature shaft 27 in the axial direction.

A support shaft (not shown) for rotatably supporting the worm wheel 52 is provided in the gear case 50, and the worm wheel 52 is rotatably provided in the gear case 50. A pinion 61 as an output shaft is provided at the rotation center of the worm wheel 52 so as to be rotatable with the worm wheel 52, and meshed with a gear (not shown) formed as a window regulator. The pinion 61 is rotatably supported by the support shaft of the gear case 50 likewise the worm wheel 52. Therefore, the rotation speeds of the armature shaft 27 and the worm shaft 51 are reduced by the worm 51a and the worm wheel 52, and an output reduced in rotation speed and increased in torque is transmitted from the pinion 61 to the gear of the window regulator. Here, the worm 51a and the worm wheel 52 configure the speed reduction mechanism in the present invention.

Three engagement projections 62a, 62b, and 62c are respectively provided on the front and rear sides of the gear case 50 in FIG. 1 (only the front side is illustrated in the drawing), and engagement claws 71a, 71b, and 71c of the connector member 70 get on the respective engagement projections 62a, 62b, and 62c so that the engagement claws 71a, 71b, and 71c engage with the respective engagement projections 62a, 62b, and 62c. Guide convex portions 63a, 63b, and 63c, which open upward in FIG. 1 and guide the engagement of the respective engagement claws 71a, 71b, and 71c with the respective engagement projections 62a, 62b, and 62c, are disposed in the vicinity of the respective engagement projections 62a, 62b, and 62c. Further, single engagement projections 62d are respectively disposed to the right and left sides of the gear case 50 in FIG. 1, and engagement claws 71d of the connector member 70 get on the respective engagement projections 62d so that the engagement claws 71d engage with the respective engagement projections 62d.

As shown in FIG. 3, the connector member 70 is formed into a bottomed shape by injection molding of resin material such as plastic and the like, and includes a main body portion 71 and a connector junction 72. The connector member 70 is attached to a side portion of the gear case 50 from outside of the worm wheel 52 in its radial direction.

The opening side of the main body portion 71 (upper side in the drawing) is formed into a substantially rectangular shape, and three engagement claws 71a, 71b, and 71c are integrally provided to a pair of long side portions on the opening side of the main body portion 71, respectively in confrontation therewith. Each length (projection size) of the engagement claws 71a, 71b, 71c from the long side portions is set so as to be gradually shortened from the near side of the connector junction 72 (on the left side in the drawing) toward the far side of the connector junction 72, and the engagement claw 71a on the near side of the connector junction 72 has a longest size, and the engagement claw 71c on the far side of the connector junction 72 has a shortest size. Further, the single engagement claws 71d are integrally disposed to a pair of short side portions on the opening side of the main body portion 71 in confrontation therewith. The length (projection size) of each of the engagement claws 71d from the short side portions are approximately as long as the length of each of the engagement claws 71c.

The main body portion 71 is configured to hold a control board (controller) 73 (refer to FIG. 6) for controlling the rotation of the rotating shaft (the armature shaft 27 and the worm shaft 51) of the power window motor 10. The main body portion 71 is provided with a pair of board support projections 71e fitted with a pair of positioning holes 73a provided to the control board 73, and a pair of board support surface portions 71f for supporting the control board 73 on their surfaces. Therefore, it is possible to hold the control board 73 at a predetermined position of the connector member 70 by causing the board support projections 71e and the board support surface portions 71f to support the control board 73. Here, a plurality of through holes 73b are formed to the control board 73, and electronic parts, for example, a CPU, a switching device and the like (not shown) other than Hall IC 55 are mounted on the control board 73.

The connector junction 72 is integrally provided to one side portion (on the left side in the drawing) of the main body portion 71 so as to project from the main body portion 71. The cross section of the connector junction 72 is formed in a substantially rectangular shape, and the inside thereof is hollow. A vehicle-side connector (not shown) is attached to the connector junction 72. The outer peripheral portion of the connector junction 72 is integrally provided with four guide projections 72a extending along the projecting direction of the connector junction 72 as shown in FIG. 5, and the guide projections 72a are configured to guide a plug of the vehicle-side connector straight. Each of the guide projections 72a is formed asymmetrically in the lateral direction (up/down direction in the drawing) of the cross section of the connector junction 72. Therefore, the vehicle-side connector can be attached to the connector junction 72 in a correct direction. The outer peripheral portion of the connector junction 72 is further integrally provided with a locking projection 72b, and the locking projection 72b is engaged with a locking claw (not shown) of the vehicle-side connector, thereby preventing the vehicle-side connector from being removed from the connector junction 72.

As shown in shaded portions of FIG. 4, two plate-like power supply conductive members 74a and 74b each of which is formed of metal material such as brass and the like excellent in conductivity into a plate, six needle-like control conductive members 75a, 75b, 75c, 75d, 75e, and 75f each of which is formed of the same material as the power supply conductive members 74a and 74b, and two motor conductive members 78a and 78b are inserted by insert-molding into the connector member 70. The power supply conductive members 74a and 74b and the control conductive members 75a, 75b, 75c, 75d, 75e, and 75f (eight members in total) are inserted into the connector member 70 under the condition that they are bent into a substantially L-shape, and one end portions thereof are disposed inside the connector junction 72, and the other end portions thereof are electrically connected to the control board 73. Further, first end portions 78a1 and 78b1 of the motor conductive members 78a and 78b are electrically connected to the brushes 32 of the brush holder 31 via conductive wires (not shown), respectively, and second end portions 78a2 and 78b2 of the motor conductive members 78a and 78b are electrically connected to the control board 73, respectively. Further, a symbol 79 denotes an element connecting conductive member, and the element connecting conductive member 79 is used as a terminal for electrically connecting a circuit element (not shown, for example, capacitor and the like) to the control board 73.

As shown in FIG. 5, one end portion of the power supply conductive member 74a functions as a power supply terminal 76a, and the power supply terminal 76a is electrically connected to a power supply terminal (12V, 24V, and the like) of the vehicle-side connector. One end of the power supply conductive member 74b functions as a ground terminal 76b, and the ground terminal 76b is electrically connected to a ground terminal (GND) of the vehicle-side connector. Further, one end portions of the control conductive members 75a, 75b, 75c, 75d, 75e, and 75f function as a window automatic opening/closing terminal (AUTO) 77a, a window lifting terminal (UP) 77b, a window lowering terminal (DOWN) 77c, an ignition detecting terminal (IG) 77d, a serial communication terminal (UART) 77e, and a spare terminal (non-connected) 77f, respectively. The control terminals 77a, 77b, 77c, 77d, 77e, and 77f are electrically connected to respective control terminals disposed so as to correspond to the vehicle-side connector.

The power supply terminal 76a and the ground terminal 76b are disposed on both sides of the connector junction 72 in a longitudinal direction so that the longitudinal direction of the power supply terminal 76a and the ground terminal 76b becomes parallel with the longitudinal direction of the connector junction 72. Additionally, the distance “L” between the power supply terminal 76a and the ground terminal 76b is set to approximately the same size as the size (thickness “h”) of the connector junction 72 in the lateral direction, and a sufficient air gap is formed therebetween. Note that each thickness of the power supply terminal 76a and the ground terminal 76b is set to 0.64 mm, and each width thereof is set to 2.30 mm.

The control terminals 77a, 77b, 77c, 77d, 77e, and 77f are disposed between the power supply terminal 76a and the ground terminal 76b, arranged in three rows at regular intervals along the longitudinal direction of the connector junction 72, and arranged in two rows at regular intervals along the lateral direction of the connector junction 72. Note that each of the thickness and the width of each of the control terminals 77a, 77b, 77c, 77d, 77e, and 77f is set to 0.64 mm, and each of the cross sections thereof is formed in a square shape. Here, each of the needle-shaped control terminals 77a, 77b, 77c, 77d, 77e, and 77f may be formed into a triangle shape, a polygon shape having five or more sides and further a circle shape in cross-section without being limited to a square shape.

In this way, the power supply terminal 76a, the ground terminal 76b, and each of the control terminals 77a, 77b, 77c, 77d, 77e, and 77f are disposed in the connector junction 72, so that the size of the connector junction 72 in the lateral direction (thickness “h”) is reduced and the connector junction 72 is downsized. Further, the minimum necessary number (six) of the control terminals 77a, 77b, 77c, 77d, 77e, and 77f for obtaining functions necessary to the power window device are disposed in the connector junction 72, so that the height “H” of the power window motor 10 (refer to FIGS. 1 and 2) is reduced by making the size (width “d”) of the connector junction 72 in the longitudinal direction smaller than the thickness “D” of the power window motor 10.

Further, the control terminals 77a, 77b, 77c, 77d, 77e, and 77f are arranged in two rows along the lateral direction of the connector junction 72, and relatively large spaces “S” are formed on the upper and lower sides of the control terminals 77a, 77b, 77c, 77e, and 77f, respectively. With the configuration, the moldability of the connector member 70 is secured by making it easy to flow the melted resin when the connector member 70 is insert-molded, while reducing the size (thickness size h) of the connector junction 72 in the lateral direction.

Then, a procedure of assembling the power window motor 10 thus configured will be described in detail with reference to the drawings.

As shown in FIG. 6, the control board 73 mounted with electronic parts such as the Hall IC 55 and the like is prepared and the connector member 70 inserted with the power supply conductive members 74a and 74b, the control conductive members 75a, 75b, 75c, 75d, 75e, and 75f, and the motor conductive members 78a and 78b is prepared. Further, a motor assembly with the motor portion 20 and the gear portion 40 being assembled (refer to FIG. 1) is prepared.

Then, as shown by an broken arrow (1) in the drawing, the control board 73 is faced to the opening side of the connector member 70, the board support projections 71e are respectively fitted with the positioning holes 73a of the control board 73, and the control board 73 is placed on the board support surface portions 71f. At this time, the other end portions of the power supply conductive members 74a and 74b, the other end portions of the control conductive members 75a, 75b, 75C, 75d, 74e, and 75f, and the second end portions 78a2 and 78b2 of the motor conductive members 78a and 78b are inserted into the respective through holes 73b of the control board 73.

Then, the other end portions of the power supply conductive members 74a and 74b, the other end portions of the control conductive members 75a, 75b, 75c, 75d, 75e, and 75f, and the second end portions 78a2 and 78b2 of the motor conductive members 78a and 78b are electrically connected to respective printed wirings (not shown) of the control board 73 by soldering and the like. In this way, a mounting process of the control board 73 on the connector member 70 is completed.

Then, the opening side of the connector member 70 is faced to a side portion of the gear case 50 on which the control board 73 is mounted, and the connector member 70 is gradually approached to the gear case 50. Thus, in order of broken arrows (2), (3), and (4) shown in the drawing, the engagement claws 71a, 71b, and 71c get on the engagement projections 62a, 62b, and 62c (refer to FIG. 1) while being guided by the guide convex portions 63a, 63b, and 63c and are pushed and widened externally. Then, the engagement claws 71a, 71b, and 71c are engaged with the engagement projections 62a, 62b, and 62c, and the mounting of the connector member 70 on the gear case 50 is completed.

At this time, approximately simultaneously with the engagement of the engagement claws 71c with the engagement projections 62c, the engagements claws 71d are engaged with the engagement projections 62d corresponding to the engagement claws 71d (refer to FIG. 1). Further, the first end portions 78a1 and 78b1 of the motor conductive members 78a and 78b are electrically connected to the conductive wires corresponding to the brushes 32. That is, power is supplied to the power window motor 10 from the power supply members 74a and 74b inserted into the connector member 70 via the control board 73 and the motor conductive members 78a and 78b. In this way, the connector member 70 can be mounted on the gear case 50 with just one touch by engaging the engagement claws 71a, 71b, 71c, and 71d with the engagement projections 62a, 62b, 62c, and 62d. Accordingly, since it is unnecessary to use screws or the like for attaching the connector member 70 to the gear case 50, it is possible to simplify a mounting operation, and further realize the reduction in weight of the power window motor 10.

As described above in detail, according to the power window motor 10 of the first embodiment, since the power supply terminal 76a and the ground terminal 76b are respectively provided to both sides of the connector junction 72 in the longitudinal direction, and the control terminals 77a, 77b, 77c, 77d, 77e, and 77f are disposed between the power supply terminal 76a and the ground terminal 76b, arranged in three rows in the longitudinal direction of the connector junction 72, and arranged in two rows in the lateral direction of the connector junction 72, the power supply terminal 76a can be separated from the ground terminal 76b. Therefore, it is possible to downsize the connector junction 72 while securing a sufficient air gap between the power supply terminal 76a and the ground terminal 76b. Further, it is possible to downsize the power window motor 10.

Further, according to the power window motor 10 of the first embodiment, since each of the power supply terminal 76a and the ground terminal 76b is formed into a flat plate, each of the control terminals 77a, 77b, 77c, 77d, 77e, and 77f is formed into a needle shape, and the power supply terminal 76a and the ground terminal 76b are provided in the connector junction 72 so that the longitudinal direction of each of the power supply terminal 76a and the ground terminal 76b becomes parallel with the longitudinal direction of the connector junction 72, it is possible to reduce the size (thickness “h”) of the connector junction 72 in the lateral direction.

Further, according to the power window motor 10 of the first embodiment, since the power supply terminal 76a and the ground terminal 76b (two terminals in total) and the control terminals 77a, 77b, 77c, 77d, 77e, and 77f (six terminals in total of the window automatic opening/closing terminal, the window lifting terminal, the window lowering terminal, the ignition detecting terminal, the serial communication terminal, and the spare terminal) are provided, it is possible to reduce the power window motor in size while constituting an optimum power window motor 10 having functions necessary as a power window device.

Then, the second embodiment of the present invention will be described hereinafter in detail with reference to the drawings. Here, portions having the same function as those of the first embodiment are denoted by the same reference numbers as those of the first embodiment and the detail descriptions thereof are omitted here.

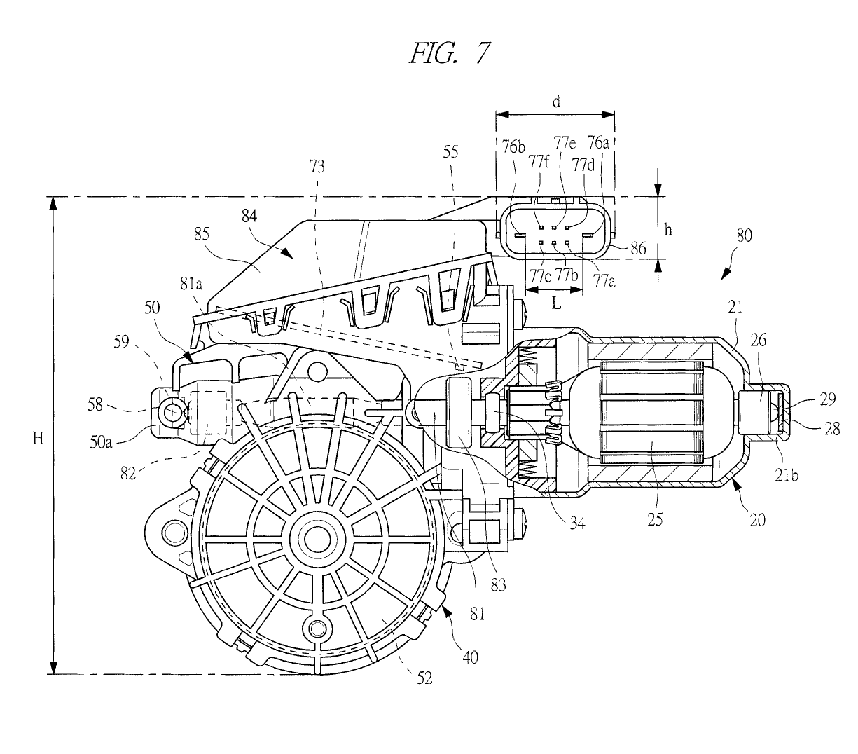

FIG. 7 is a partial cross-sectional view showing a power window motor according to the second embodiment of the present invention.

As shown in FIG. 7, a power window motor 80 according to the second embodiment is different, as compared with the power window motor 10 of the first embodiment described above, in that a single rotating shaft 81 is provided by integrating the armature shaft 27 with the worm shaft 51 and a connector junction 86 opens toward the side opposite to the side where the pinion 61 is disposed (refer to FIG. 1).

The rotating shaft 81 passes through and fixed to the center of rotation of the armature 25. One end (right side in the drawing) of the rotating shaft 81 is disposed inside a yoke 21 and rotatably supported by a bottomed cylinder portion 21b of the yoke 21 via a first radial bearing 26, a first thrust bearing 28, and a first steel ball 29. The other end portion (left side in the drawing) of the rotating shaft 81 is provided in a gear case 50 and rotatably supported by a bottom portion 50a of the gear case 50 via a fifth radial bearing 82, a second thrust bearing 58, and a second steel ball 59.

A worm 81a, which is meshed with the gear teeth of a worm wheel 52, is integrally provided to the other end portion of the rotating shaft 81. A sensor magnet 83 is fixed to a portion of the rotating shaft 81 close to the second radial bearing 34. The sensor magnet 83 is disposed in face-to-face relationship with a Hall IC 55 that forms a rotation sensor together with the sensor magnet 83.

The connector junction 86 is integrally provided to one side portion of (right side in the drawing) of a main body portion 85 in a connector member 84. The connector junction 86 is extended in the longitudinal direction of the main body portion 85, and projected in the lateral direction of the main body portion 85. However, the amount of projection of the connector junction 86 is suppressed in the lateral direction to be smaller than the thickness of the power window motor 80 (the same thickness size “D” as a power window motor 10).

The connector junction 86 opens toward the side opposite to the side where the pinion 61 (refer to FIGS. 1 and 2) is disposed, i.e., the front side of the power window motor 80 (back side). The pinion 61 is disposed to face outside of a vehicle, and the connector junction 86 opens toward inside of a passenger compartment (not shown).

The power window motor 80 thus configured as mentioned above according to the second embodiment can attain the same advantageous effects of the first embodiment mentioned above.

Since the power window motor 80 according to the second embodiment is provided with only the single rotating shaft 81, the armature shaft 27 and the worm shaft 51 cannot be individually designed as dedicated members, and unlike those of the first embodiment. However, since a coupling member 53 is not necessary, it is possible to reduce the number of parts and the number of assembly steps. Further, in the power window motor 80 according to the second embodiment, since the connector junction 86 opens toward inside of the passenger compartment, a process of connecting a vehicle-side connector with the connector junction 86 can be made easy, and thus the mounting property of the power window motor 80 on the vehicle and the maintenance property of the power window motor 80 can be improved.

It is needless to say that the present invention is by no means limited to the above embodiments and can be variously modified within the range which does not depart from the gist of the invention. For example, the above embodiments show that the power supply terminal 76a and the ground terminal 76b are disposed so that the longitudinal direction of the power supply terminal 76a and the ground terminal 76b becomes parallel with the longitudinal direction of the connector junction 72 (86). However, the invention is by no means limited to this configuration, and, for example, the longitudinal direction of the power supply terminal 76a and the ground terminal 76b may be orthogonal to the longitudinal direction of the connector junction 72 (86).

Further, in each embodiment, the motor with speed reduction mechanism is applied to a power window motor of the power window device. However, the present invention may be applied to a driving source of a sun-roof device and the like without being limited to this device.

The motor with speed reduction mechanism is used to drive the window regulator of the power window device mounted on a vehicle such as automobile and the like to lift up and down a window glass.

While the present invention has been illustrated and described with respect to a particular embodiment thereof, it should be appreciated by those of ordinary skill in the art that various modifications to this invention may be made without departing from the spirit and scope of the present.

What is claimed is:

1. A motor with speed reduction mechanism having a speed reduction mechanism for reducing the speed of rotation of a rotating shaft and outputting the speed-reduced rotation and a controller for controlling the rotation of the rotating shaft, the motor comprising:
a motor case;
an armature shaft provided in the motor case and forming the rotating shaft;
a gear case attached to the motor case;
a worm shaft provided in the gear case and coupled with the armature shaft to form the rotating shaft;
a worm provided to the worm shaft and forming the speed reduction mechanism;
a worm wheel provided in the gear case and meshed with the worm to form the speed reduction mechanism;
a connector member attached to the gear case and configured to hold the controller;
a connector junction provided to the connector member and having a rectangular shape in cross section; and
eight conductive members inserted into the connector member, one end portions of the conductive members being disposed in the connector junction, and the other end portions of the conductive members being electrically connected to the controller,
wherein two of the conductive members are respectively used as power supply conductive members, the other six conductive members are respectively used as control conductive members, one end portions of the power supply conductive members are respectively disposed on both sides of the connector junction in longitudinal direction, and one end portions of the control conductive members are disposed between the power supply conductive members, arranged in two rows in longitudinal direction, and arranged in three rows in lateral direction.

2. The motor with speed reduction mechanism according to claim 1, wherein each of the power supply conductive members is formed into a flat plate, each of the control conductive members is formed into a needle shape, and one end portions of the power supply conductive members are disposed in the connector junction so that the longitudinal direction of the power supply conductive members becomes parallel with the longitudinal direction of the connector junction.

3. The motor with speed reduction mechanism according to claim 1, wherein the motor with speed reduction mechanism is a power window motor mounted on a vehicle, one end portions of the power supply conductive members are respectively used as a power supply terminal and a ground terminal, and one end portions of the control conductive members are respectively used as a window automatic opening/closing terminal, a window lifting terminal, a window lowering terminal, an ignition detecting terminal, a serial communication terminal, and a spare terminal.

4. A motor with speed reduction mechanism having a speed reduction mechanism for reducing the speed of rotation of a rotating shaft and outputting the speed-reduced rotation and a controller for controlling the rotation of the rotating shaft, the motor comprising:
a motor case in which one end portion of the rotating shaft is provided;
a gear case attached to the motor case and having the other end portion of the rotating shaft provided therein;
a worm provided to the other end portion of the rotating shaft and forming the speed reduction mechanism;
a worm wheel provided in the gear case and meshed with the worm to form the speed reduction mechanism;
a connector member attached to the gear case and configured to hold the controller;
a connector junction provided to the connector member and having a rectangular shape in cross section; and
eight conductive members inserted into the connector member, one end portions of the conductive members being disposed in the connector junction, and the other end portions of the conductive members being electrically connected to the controller,
wherein two of the conductive members are respectively used as power supply conductive members, the other six conductive members are respectively used as control conductive members, one end portions of the power supply conductive members are respectively disposed on both sides of the connector junction in longitudinal direction, and one end portions of the control conductive members are disposed between the power supply conductive members, arranged in two rows in longitudinal direction, and arranged in three rows in lateral direction.

5. The motor with speed reduction mechanism according to claim 4, wherein each of the power supply conductive members is formed into a flat plate, each of the control conductive members is formed into a needle shape, and one end portions of the power supply conductive members are disposed in the connector junction so that the longitudinal direction of the power supply conductive members becomes parallel with the longitudinal direction of the connector junction.

6. The motor with speed reduction mechanism according to claim 4, wherein the motor with speed reduction mechanism is a power window motor mounted on a vehicle, one end portions of the power supply conductive members are respectively used as a power supply terminal and a ground terminal, and one end portions of the control conductive members are respectively used as a window automatic opening/closing terminal, a window lifting terminal, a window lowering terminal, an ignition detecting terminal, a serial communication terminal, and a spare terminal.
